(19) United States
(12) Patent Application Publication
(10) Pub. No.: US 2004/0095037 A1
(43) Pub. Date: May 20, 2004

(54) Low profile motor with internal gear train

(76) Inventor: Albert Palmero, Middlefield, CT (US)

Correspondence Address: JOHN H CROZIER, 1934 HUNTINGTON TURNPIKE, TRUMBULL, CT, 06611

(21) Appl. No.: 10/472,133

(22) PCT Filed: Mar. 22, 2002
(86) PCT No.: PCT/US02/09099

(51) Int. Cl. H02K 1/22

(52) U.S. Cl. 310/261

(57) ABSTRACT

The invention relates to an electromagnetic machine (10) having a permanent-magnet rotor assembly (54, 56); a stator assembly (58, 64, 60, 100) disposed coaxially with the rotor assembly, wherein the rotor define an interior spaced volume and gear assembly (38, 40, 46) disposed within the volume; the gear assembly being attached to and disposed between the rotor and an output shaft (30) of the motor.

### TECHNICAL FIELD

The present invention relates to motors generally and, more particularly, but not by way of limitation, to a novel low profile motor with an internal gear train.

### BACKGROUND ART

It is known that the efficiency of a stepper motor is related to the ratio of the rotor diameter to the motor diameter. One measurement of this ratio shows that the maximum efficiency of a stepper motor occurs at approximately 65 percent of rotor diameter to motor diameter. When this ratio is optimized, a substantial part of the space inside the rotor of the motor is wasted. One approach to using this wasted space is to place a first motor coil outside the rotor and a second motor coil inside the rotor, thereby developing a low profile electric motor. Although this uses the wasted space, any gearing employed must be external to the motor, thus resulting in a package that has a total width greater than the width of the motor itself.

Accordingly, it is a principal object of the present invention to provide a motor that has internal gearing.

It is a further object of the invention to provide such a motor in which the gearing is placed in otherwise wasted space.

It is an additional object of the invention to provide such a motor that can be economically constructed.

Other objects of the present invention, as well as particular features, elements, and advantages thereof, will be elucidated in, or be apparent from, the following description and the accompanying drawing figures.

### DISCLOSURE OF INVENTION

The present invention achieves the above objects, among others, by providing, in a preferred embodiment, an electromagnetic machine, comprising: a rotor disposed in said electromagnetic machine; a stator structure disposed in said electromagnetic machine, said rotor defining a volume interiorly of said rotor, and gearing disposed in said volume, said gearing being attached to and disposed between said rotor and an output shaft of said motor.

### BRIEF DESCRIPTION OF DRAWINGS

Understanding of the present invention and the various aspects thereof will be facilitated by reference to the accompanying drawing figures, provided for purposes of illustration only and not intended to define the scope of the invention, on which:

FIG. 1 is a graph of torque versus rotor diameter for a stepper motor.

FIG. 2 is an exploded isometric view of a motor constructed according to the present invention.

FIG. 3 is an isometric view of the motor.

FIG. 4 is a side elevational view of the motor.

FIG. 5 is a front elevational view of the motor taken along line “5-5” of FIG. 4.

FIG. 6 is a side elevational view, in cross-section, of the motor.

### BEST MODE FOR CARRYING OUT THE INVENTION

Reference should now be made to the drawing figures on which similar or identical elements are given consistent identifying numerals throughout the various figures thereof, and on which parenthetical references to figure numbers direct the reader to the view(s) on which the element(s) being described is (are) best seen, although the element(s) may be seen on other figures also.

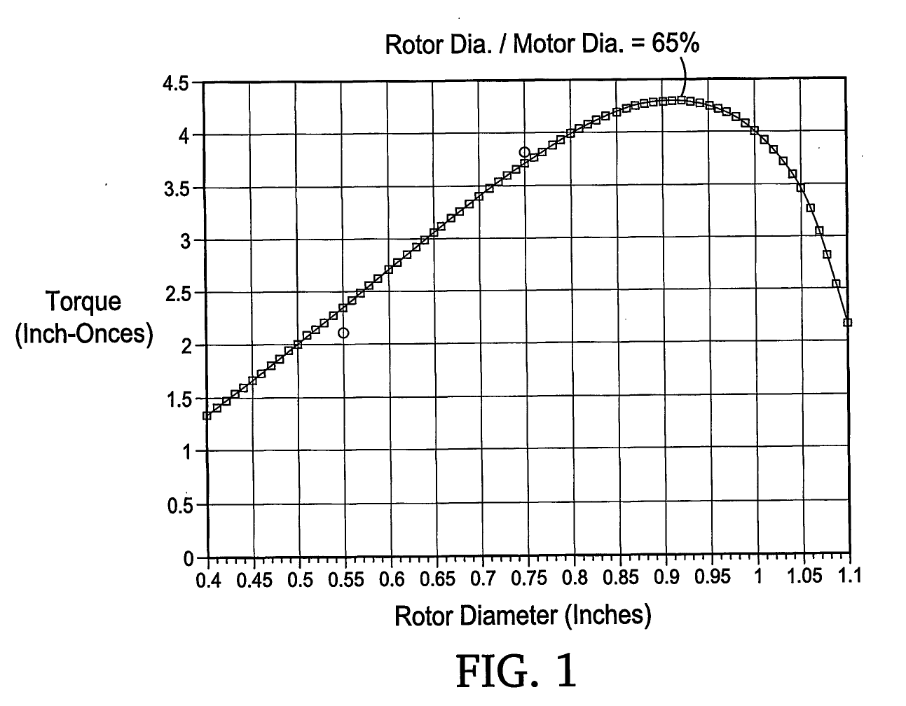

FIG. 1, taken from U.S. Pat. No. 4,841,189, titled STEPPER MOTOR AND METHOD OF MAKING THE SAME, is a graph of torque vs. rotor diameter for a stepper motor, showing that maximum torque is obtained at a particular rotor diameter. In this case, the maximum torque is obtained when the rotor diameter is approximately 65 percent of the motor diameter. This, of course, means that there is a large amount of wasted interior space in a conventional motor. As noted in that patent, the ratio of rotor diameter to motor diameter is preferably in the range of 55 to 75 percent.

The present invention uses this otherwise wasted space by providing therein gearing for the motor that would normally be disposed exteriorly of the motor. While the gearing in this case is shown as being a planetary gear train, other types of gearing may be provided as well and such is within the contemplation of the present invention.

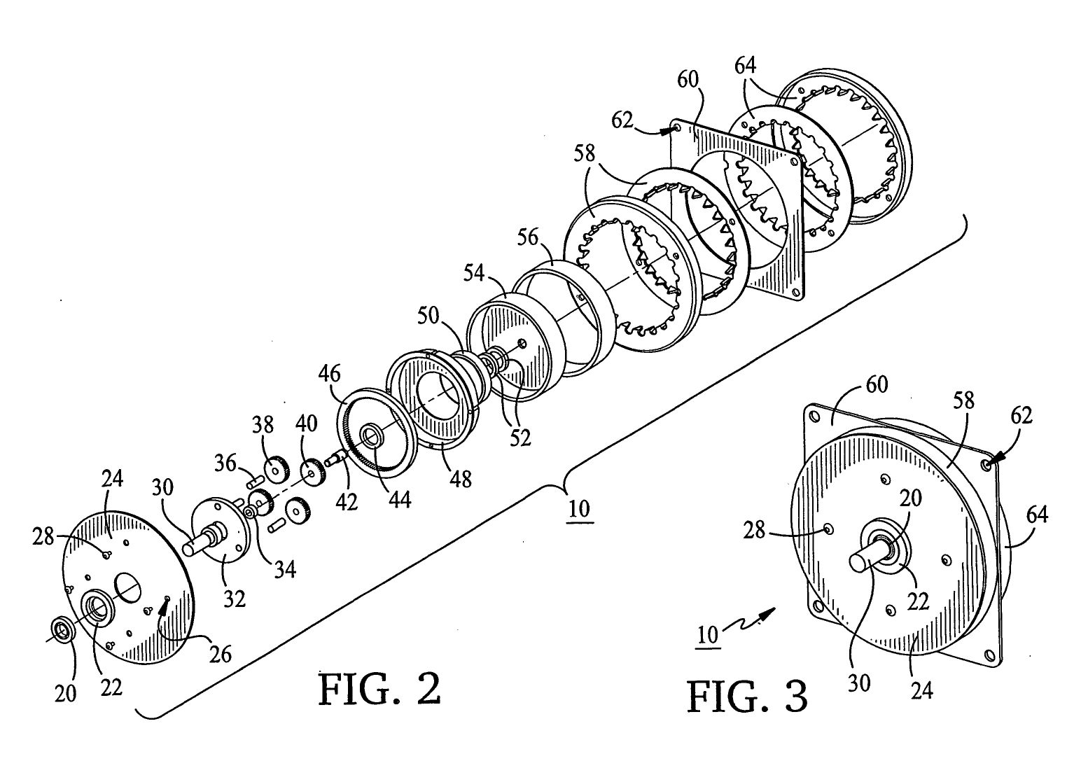

FIG. 2 illustrates an exploded view of a motor constructed according to the present invention, the motor being generally indicated by the reference numeral 10. The elements of motor 10 shown on FIG. 2 are described below from the lower left hand corner to the upper right hand corner. The first element is a ball bearing 20, then a bearing bushing 22, a front cover 24 having defined therethrough four openings, as at 26, to accommodate therein four button head screws, as at 28, an output shaft 30, an output driver disk 32, a sleeve bearing 34, three pins, as at 36, serving as shafts for three planet gears, as at 38, a sun gear 40, a motor shaft 42, a ball bearing 44, a ring gear 46, a ring gear housing 48, a bearing support 50, ball bearings 52, a rotor support 54, a rotor magnet 56, two front field rings 58, a mounting flange 60 having defined therethrough four mounting holes, as at 62, and two rear field rings 64. For clarity, the windings in front and rear field rings 58 and 64 are not shown on FIG. 2.

The assembled relationship of the foregoing elements of motor 10 will more clearly be understood by reference to the following drawing figures.

FIG. 3 illustrates motor 10 with the elements thereof (FIG. 2) in assembled relationship. Mounting holes 62 can be used to attach motor 10 to the surface of other equipment (not shown).

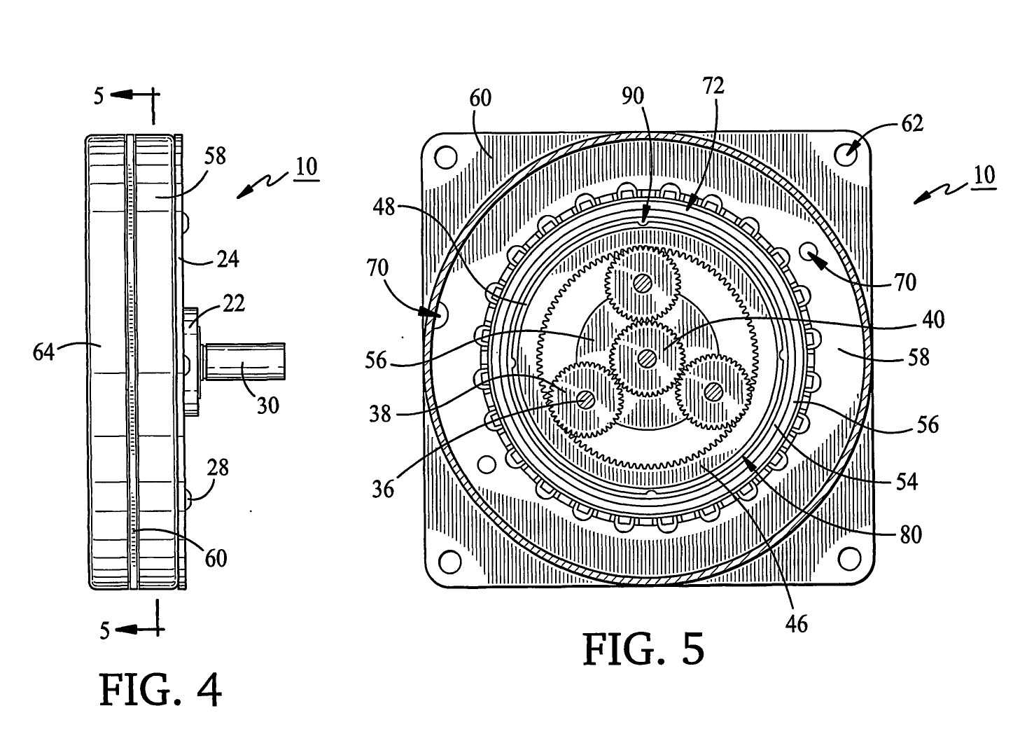

FIG. 4 also shows motor 10 with the elements thereof (FIG. 2) in assembled relationship.

FIG. 5 illustrates the elements of the planet gear in motor 10. For clarity, the winding in front field ring 58 is not shown on FIG. 5. In addition to the elements of motor 10 previously described with reference primarily to FIG. 2, the following elements of motor 10 are shown on FIG. 5. Openings 70 are provided for alignment of the elements of motor 10 during manufacture. An air gap 72 is provided between field ring 58 and rotor magnet 56. Another air gap 80 is provided between rotor magnet support 54 and ring gear housing 48.

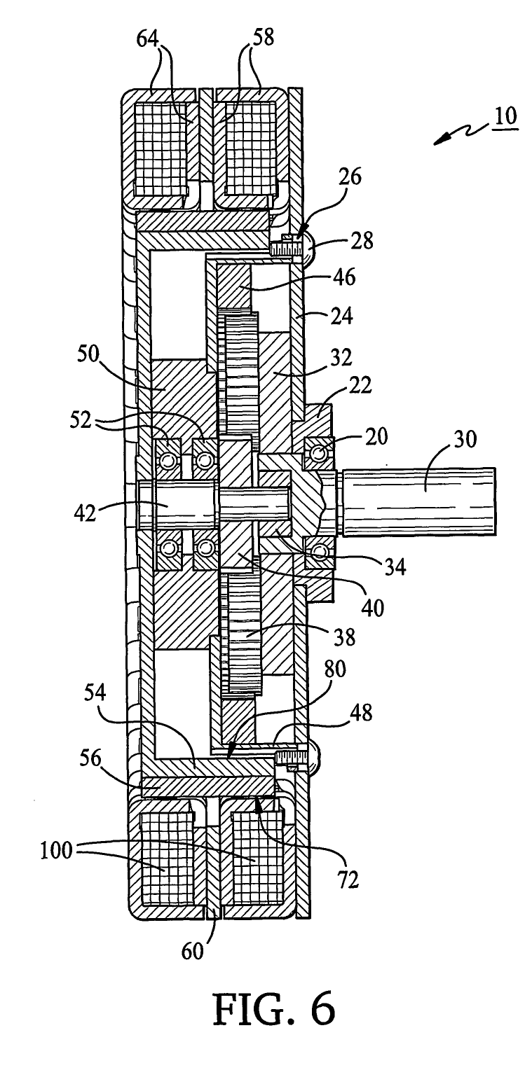

FIG. 6 illustrates the elements of motor 10 described above with reference to FIGS. 2 and 5. FIG. 6 also shows windings 100 disposed in front and rear field rings 58 and 64, the windings not being shown on the other drawing figures.

In operation and with continuing reference to FIG. 6, rotor magnet 56 is magnetically coupled to windings 100 that, in a conventional manner, impart rotational motion to the rotor magnet. Rotor magnet 56 is fixedly attached to rotor magnet support 54 that imparts the rotational motion to sun gear 40 through motor shaft 42. Rotation of sun gear 40 causes rotation of planet gears 38 around the inner surface of ring gear 46 which is fixedly disposed with respect to motor 10. Rotation of planet gears 38 around ring gear 46 causes rotation of output driver disk 32 by means of pins 36, which in turn causes rotation of output shaft 30 fixedly attached to the output driver disk.

It will be understood that the torque of shaft 30 will be greater than that otherwise generated by motor 10 and that the rotational speed thereof will be less than that otherwise generated by motor 10. The degrees of torque and speed produced by motor 10 will depend on the relative sizes of the elements of the planetary gear.

The diameter of motor 10 is about 4.6 times the thickness thereof.

Terms such as “upper”, “lower”, “inner”, “outer”, “inwardly”, “outwardly”, “vertical”, “horizontal”, and the like, when used herein, refer to the positions of the respective elements shown on the accompanying drawing figures and the present invention is not necessarily limited to such positions.

It will thus be seen that the objects set forth above, among those elucidated in, or made apparent from, the preceding description, are efficiently attained and, since certain changes may be made in the above construction without departing from the scope of the invention, it is intended that all matter contained in the above description or shown on the accompanying drawing figures shall be interpreted as illustrative only and not in a limiting sense.

It is also to be understood that the following claims are intended to cover all of the generic and specific features of the invention herein described and all statements of the scope of the invention which, as a matter of language, might be said to fall therebetween.

I claim:

1. An electromagnetic machine, comprising:
(a) a rotor disposed in said electromagnetic machine;
(b) a stator structure disposed in said electromagnetic machine;
(c) said rotor defining a volume interiorly of said rotor; and
(d) gearing disposed in said volume, said gearing being attached to and disposed between said rotor and an output shaft of said motor.

2. An electromagnetic machine, as defined in claim 1, wherein: ratio of diameter of said rotor to diameter of said motor is about 55 percent to about 75 percent.

3. An electromagnetic machine, as defined in claim 1, wherein: a diameter of said motor is about 4.6 times a thickness of said motor.

4. An electromagnetic machine, as defined in claim 1, wherein: said gearing comprises a planetary gear train.
